(19) United States
(12) Patent Application Publication
(10) Pub. No.: US 2010/0319012 A1
(43) Pub. Date: Dec. 16, 2010

(54) Spindle Motor Assembly With Encoder

(76) Inventors: Ho Jun Yoo, Gyunggi-do (KR); Sang Kyu Lee, Gyunggi-do (KR); Byung Hoon Lee, Seoul (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/539,548

(22) Filed: Aug. 11, 2009

(30) Foreign Application Priority Data
Jun. 10, 2009 (KR) 10-2009-0051610

(51) Int. Cl. G11B 17/028

(52) U.S. Cl. 720/695; G9B/17.006

(57) ABSTRACT

The present invention provides a spindle motor assembly with an encoder. The spindle motor includes a circuit board, a spindle motor and an encoder. A connector is mounted on the upper surface of the circuit board. The spindle motor is provided on the circuit board. The spindle motor functions to rotate a disk placed thereon. The encoder is provided on the connector and senses a detection mark of the disk and thereby detects a rotating speed of the disk. As such, because the encoder is installed on the connector, the number of components is reduced, and the production cost can be thus reduced.

### CROSS REFERENCE TO RELATED APPLICATION

This application claims the benefit of Korean Patent Application No. 10-2009-0051610, filed Jun. 10, 2009, entitled “SPINDLE MOTOR ASSEMBLY MOUNTED ENCODER”, which is hereby incorporated by reference in its entirety into this application.

### BACKGROUND OF THE INVENTION

1. Technical Field

The present invention relates to a spindle motor assembly with an encoder.

2. Description of the Related Art

As is well known to those skilled in the art, a spindle motor is installed in an ODD (optical disk drive) and rotates a disk to enable an optical pickup which linearly moves to read data recorded on the disk.

According to the technical development of the ODD, ODDs are being developed and used which have a lightscribe function which prints a desired design on the surface of a CD (compact disk) or a DVD (digital versatile disk) using a laser. The disk must rotate at a relatively high speed of about 5,400 rpm for data to be extracted from the disk or for data to be recorded on the disk, whereas the disk must rotate at a relatively low speed of about 40 rpm when a design is printed on the surface of the disk.

For this, an encoder is installed in the spindle motor to detect whether the disk is rotating at an appropriate speed when a design is being printed on the surface of the disk.

FIGS. 1 and 2 respectively are a plan view and a sectional view showing the partial construction of a spindle motor with an encoder, according to a conventional technique. The installation structure of the encoder according to the conventional technique will be explained with reference to these drawings.

As shown in FIGS. 1 and 2, a circuit board 20 is attached to an upper surface of a base plate 10. Also, an encoder 40 is installed on the circuit board 20 at a location below a detection mark 52 of a disk 50, the disk being placed on a turntable.

Because of multi-functionalization and increasing complexity of an IC driving the motor, and in response to an increase in the necessity of installing complex and various circuits and chips in a relatively small space, many devices, for example, semiconductor ICs (not shown), chip devices (not shown), a connector 60, etc., are mounted to the upper surface of the circuit board 20 attached to the base plate 10.

Here, the encoder 40 must be spaced apart from the disk 50 by a predetermined distance to ensure the precision of measurement. Thus, a separate support member is installed on the upper surface of the circuit board 20, and the encoder 40 is provided on the upper end of the support member.

For this, the conventional spindle motor includes a support member 30a which has a structure in which a holder 32 and an auxiliary PCB 34 are integrated on the circuit board 20, and terminals 36 are provided through the holder 32 and the auxiliary PCB 34.

However, in the conventional spindle motor, because the separate support member 30a including the holder 32 and the auxiliary PCB 34 is installed on the circuit board 20, the number of components is increased, with the result that the production cost is increased.

In an effort to overcome the above problems, a technique for installing an encoder using a double-sided PCB was proposed in [Patent Document 1]. This is illustrated in FIG. 3.

As shown in FIG. 3, in [Patent Document 1], a double-sided PCB 30b is mounted to a main PCB 20. An encoder 40 is installed on the upper end of the double-sided PCB 30b. Thus, in this encoder installation structure, a separate member, such as a holder or the like, is not required.

However, the encoder installation structure of [Patent Document 1] still requires a separate support member for supporting the encoder 40, that is, it requires the double-sided PCB 30b. Hence, in the same manner of the encoder installation structure shown in FIGS. 1 and 2, the number of components is increased. Thus, the problem of an increase in the production cost still remains.

Moreover, as shown in FIGS. 1 through 3, in the cases where a separate support member for supporting the encoder is installed on the circuit board, an installation space of other components including a connector 60 is reduced, and installation positions thereof are also limited. Particularly, multi-functionalization and increasing complexity of an IC driving the motor has led to an increasing number of components being mounted to the circuit board 20, which has made these problems worse.

[Patent Document 1] Korean Patent Publication No. 2007-0092434

### SUMMARY OF THE INVENTION

The present invention has been made in an effort to provide a spindle motor assembly with an encoder which reduces the number of components, thus reducing the production cost, and increasing the spatial utilization.

In a spindle motor assembly according to an embodiment of the present invention, a circuit board is provided with a connector mounted on an upper surface thereof. A spindle motor is provided on the circuit board. The spindle motor rotates a disk placed thereon. An encoder is provided on the connector. The encoder senses a detection mark of the disk to detect a rotating speed of the disk.

The connector may be mounted on the circuit board under the disk at a position corresponding to the detection mark of the disk so as to detect the detection mark.

Furthermore, a pin extension may be provided on an upper surface of the connector. The pin extension may be connected to a connector pin which is electrically connected to the circuit board. The encoder may be connected to the pin extension.

The encoder may have an encoder pin connected to the pin extension by soldering.

The spindle motor may include a rotating shaft, a rotor casing, a bearing holder, an armature and a base plate. The rotor casing may be fitted at a central portion thereof over the rotating shaft. The rotor casing may integrally rotate along with the rotating shaft. A rotor magnet may be attached to an inner surface of the rotor casing. The disk may be placed on the rotor casing. The bearing holder may have therein a bearing for rotatably supporting the rotating shaft. The armature may be provided on the circumferential outer surface of the bearing holder such that the armature faces the rotor magnet, so that when external power is applied to the armature, the armature rotates the rotor casing in conjunction with the rotor magnet. The bearing holder may be fastened to the base plate. The circuit board may be attached to an upper surface of the base plate.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 respectively are a plan view and a sectional view showing the partial construction of a spindle motor with an encoder, according to a conventional technique;

FIG. 3 is a sectional view showing the construction of a spindle motor, according to another conventional technique;

FIGS. 4 and 5 respectively are a sectional view and a partial plan view of a spindle motor assembly with an encoder, according to an embodiment of the present invention; and

FIG. 6 is a view illustrating the connection between a connector and an encoder according to the embodiment of the present invention.

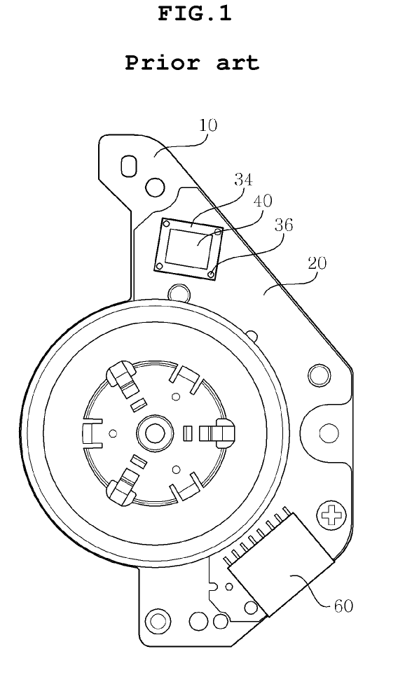

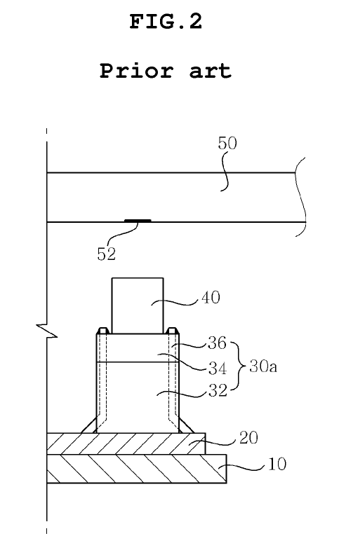

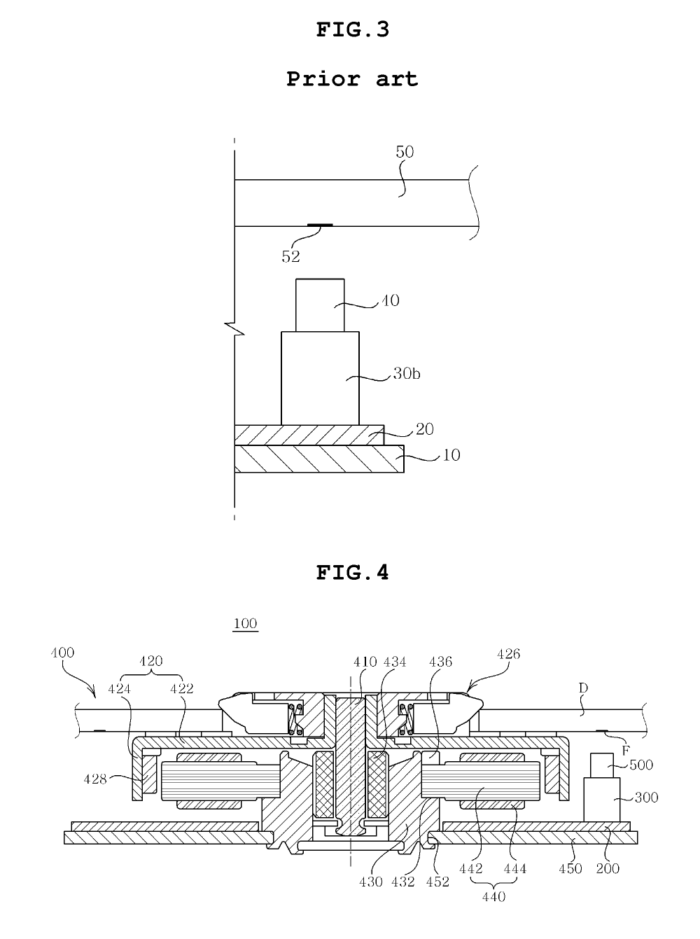

### DESCRIPTION OF THE PREFERRED EMBODIMENTS

Reference now should be made to the drawings, in which the same reference numerals are used throughout the different drawings to designate the same or similar components. In the following description, when it is determined that the detailed description for the conventional function and conventional structure would confuse the gist of the present invention, the description may be omitted. Furthermore, the terms and words used in the specification and claims are not necessarily limited to typical or dictionary meanings, but must be understood to indicate concepts selected by the inventor as the best method of illustrating the present invention, and must be interpreted as having meanings and concepts adapted to the scope and sprit of the present invention for understanding the technology of the present invention.

Hereinafter, an embodiment of the present invention will be described in detail with reference to the attached drawings.

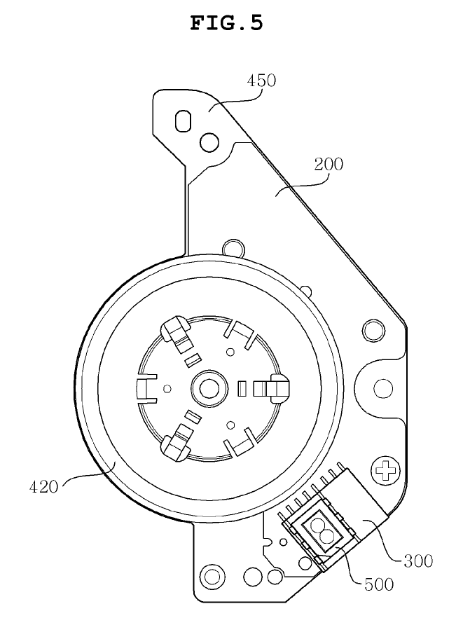

FIG. 4 is a sectional view of a spindle motor assembly 100 with an encoder 500, according to the embodiment of the present invention. FIG. 5 is a partial plan view of the spindle motor assembly 100 of FIG. 4. The spindle motor assembly 100 according to the embodiment of the present invention will be described in detail with reference to these drawings.

As shown in FIGS. 4 and 5, the spindle motor assembly 100 according to the embodiment of the present invention includes a circuit board 200, a spindle motor 400 and the encoder 500. The encoder 500 is mounted on an upper end of a connector 300 provided on the circuit board 200.

The circuit board 200 controls a drive signal of the spindle motor 400 and is provided on a base plate 450. A variety of components including the connector 300 are mounted to the upper surface of the base plate 450.

In the embodiment, the connector 300 functions as a holder for mounting the encoder thereon as well as functioning in its original capacity as a connector. For this, the connector 300 is mounted to the circuit board 200 at a position at which the encoder 500 must be disposed. That is, the connector 300 is mounted to the circuit board 200 below a detection mark F.

The connector 300 has connector pins 320 which are electrically connected to the circuit board 200. Pin extensions 340 which are connected to the corresponding connector pins 320 are provided on the connector 300. Preferably, the shape of the pin extension 340 is determined in consideration of the number and size of the encoder pins 520 of the encoder 500 provided on the connector 300.

Furthermore, the connector 300 may be of a variety of heights such that the encoder 500 is confined to within a predetermined distance of the detection mark F in consideration of the kind (size) of the spindle motor assembly. Recently, a connector having a height of 2 mm or 1 mm is being mainly used in spindle motors.

Typically, an encoder holder (support) having a height ranging from 2.4 mm to 2.5 mm is used in a 12.7 mm-lightscribe spindle motor. An encoder holder (support) having a height ranging from 1.2 mm to 1.4 mm is used in a 9.5 mm-lightscribe spindle motor. In the case of the former, a connector having a height of 2 mm can substitute for the encoder holder. In the case of the latter, a connector having a height of 2 mm can be used to substitute for the encoder holder.

The spindle motor 400 is installed on the circuit board 200 and rotates a disk D placed thereon. The spindle motor 400 includes a rotating shaft 410, a rotor casing 420, a bearing holder for supporting a bearing 434 therein, an armature 440 and a base plate 450.

The rotating shaft 410 is inserted into the central portion of the rotor casing 420 to support the rotor casing 420 thereon. The disk D is loaded on the rotor casing 420. The rotating shaft 410 has a cylindrical shape having a predetermined diameter. The lower end of the rotating shaft 410 is supported in an axial direction by a thrust washer (not designated by a reference numeral). The thrust washer is fastened to a thrust washer cover (not designated by a reference numeral).

The rotor casing 420 functions to load and support the disk D thereon. The central portion of the rotor casing 420 is fitted over the rotating shaft 410 so that the rotor casing 420 is integrally rotated with the rotating shaft 410.

The rotor casing 420 includes a circular plate 422 which is fitted over the rotating shaft 410 and extends outwards in a direction perpendicular to the rotating shaft 410, and an annular rim 424 which extends downwards from the outer edge of the circular plate 422 in a direction perpendicular to the circular plate 422. A chucking assembly 426 which releasably holds the disk D placed on the rotor casing 420 is provided on the circular plate 422. Furthermore, a rotor magnet 428 is attached to the circumferential inner surface of the annular rim 424. The rotor magnet 428 generates electromagnetic force in conjunction with a coil 444 of the armature 440 to rotate the rotor casing 420.

The bearing holder 430 serves to support the bearing 434 which rotatably supports the rotating shaft 410. The circumferential inner surface of the bearing holder 430 supports the bearing 434.

In detail, the bearing holder 430 is inserted into a coupling hole 452 of the base plate 450, and the lower end of the bearing holder 430 adjacent to the base plate 450 is fastened to the base plate 450 by caulking or spinning.

Furthermore, the bearing holder 430 has a hollow cylindrical shape. The circumferential outer surface of the bearing holder 430 has a stepped shape to form thereon a seating surface 432 onto which a core 442 of the armature 440 is seated. In addition, the lower end of the bearing holder 430 is treated by caulking or spinning towards the lower surface of the thrust washer cover to support the thrust washer cover which is disposed in the lower portion of the bearing holder 430.

The armature 440 generates an electric field using external power applied thereto. The armature 440 includes the core 442 and the coil 444.

The core 442 is fitted over the seating surface 432 of the bearing holder 430. The coil 444 generates an electric field using external power applied thereto to rotate the rotor casing 420 using force generated between it and the rotor magnet 428 of the rotor casing 420. The coil 444 is wound around the core 442 many times.

Meanwhile, an annular attractive magnet 436 is provided on the armature 440 to attract the rotor casing 420, thus preventing the rotor casing 420 from undesirably being lifted due to the rotation of the disk. In FIG. 4, although the attractive magnet 436 has been illustrated as being installed on the armature 440, it may be provided on the bearing holder 430.

The base plate 450 functions to support the entire spindle motor 400. The base plate 450 is fastened to a housing of an apparatus, such as a hard disk drive, in which the spindle motor 400 is installed. The circuit board 200 is provided on the base plate 450. A circuit (not shown) along which electricity flows to rotate the spindle motor 400 is formed on the circuit board 200. The bearing holder 430 is coupled at a predetermined position to the base plate 450.

The encoder 500 emits a light beam onto the detection mark F of the disk D to detect a rotating speed of the rotor casing 420 on which the disk D is placed and to control it. In consideration of a focal point of a light beam formed on the disk D, the encoder 500 is installed such that it is spaced apart from the disk D by a distance ranging from about 1 mm to about 2 mm.

In the embodiment, the encoder 500 is provided on the upper end of the connector 300 mounted to the circuit board 200. Thereby, a separate support member is not required.

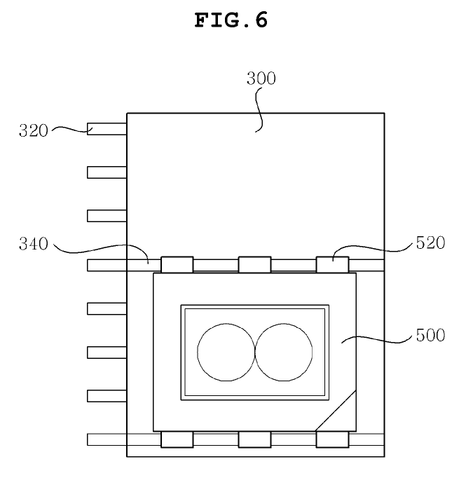

Meanwhile, the encoder 500 is electrically connected to the connector 300. The connection structure between the encoder 500 and the connector 300 will be illustrated in detail in the description pertaining to FIG. 6.

FIG. 6 is a view illustrating the connection between the connector 300 and the encoder 500 according to the embodiment of the present invention.

As shown in FIG. 6, the encoder pins 520 of the encoder 500 are electrically connected to the pin extensions 340 which extend predetermined lengths on the upper surface of the connector 300 in a state in which they are connected to the connector pins 320 of the connector 300 which is electrically connected to the circuit board 200. Here, to increase the reliability of the connection, the encoder pins 520 are preferably connected to the corresponding pin extensions 340 of the connector 300 by soldering or welding (ultrasonic welding).

In FIG. 6, although the encoder 500 has been illustrated as being connected to the connector 300 in such a manner as to connect the encoder pins 520 of the encoder 500 to the pin extensions 340 provided on the connector 300, this is only one example of the connection structure between the connector 300 and the encoder 500, and various connection structures, for example, those using wiring, soldering or plating, may be used.

As described above, in a spindle motor assembly with an encoder according to the present invention, an encoder is installed on a connector mounted to a circuit board. Hence, a separate support member is not required when installing the encoder, thus reducing the number of components and the production cost, and increasing the spatial utilization.

Furthermore, since a typical connector having a variety of heights can be used, the distance between the encoder and the disk (depending on the kind of spindle motor) can be easily adjusted.

Although the embodiment of the present invention has been disclosed for illustrative purposes, it will be appreciated that a spindle motor assembly with an encoder according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor assembly, comprising:
a circuit board provided with a connector mounted on an upper surface thereof;
a spindle motor provided on the circuit board, the spindle motor rotating a disk placed thereon; and
an encoder provided on the connector, the encoder sensing a detection mark of the disk to detect a rotating speed of the disk.

2. The spindle motor assembly as set forth in claim 1, wherein the connector is mounted on the circuit board under the disk at a position corresponding to the detection mark of the disk so as to detect the detection mark.

3. The spindle motor assembly as set forth in claim 1, wherein a pin extension is provided on an upper surface of the connector, the pin extension being connected to a connector pin which is electrically connected to the circuit board, and the encoder is connected to the pin extension.

4. The spindle motor assembly as set forth in claim 3, wherein the encoder has an encoder pin connected to the pin extension by soldering.

5. The spindle motor assembly as set forth in claim 1, wherein the spindle motor comprises:
a rotating shaft;
a rotor casing fitted at a central portion thereof over the rotating shaft, the rotor casing integrally rotating along with the rotating shaft, with a rotor magnet attached to an inner surface of the rotor casing, wherein the disk is placed on the rotor casing;
a bearing holder having therein a bearing for rotatably supporting the rotating shaft;
an armature provided on a circumferential outer surface of the bearing holder such that the armature faces the rotor magnet, so that when external power is applied to the armature, the armature rotates the rotor casing in conjunction with the rotor magnet; and
a base plate to which the bearing holder is fastened, with the circuit board attached to an upper surface of the base plate.
